(19) United States
(12) Patent Application Publication
(10) Pub. No.: US 2014/0300982 A1
(43) Pub. Date: Oct. 9, 2014

(54) ELECTRO-OPTICAL DEVICE, ELECTRONIC APPARATUS, AND MANUFACTURING METHOD FOR ELECTRO-OPTICAL DEVICE

(71) Applicant: SEIKO EPSON CORPORATION, TOKYO (JP)

(72) Inventors: Satoshi Ito, Eniwa-shi (JP); Jun Araya, Chitose-shi (JP)

(73) Assignee: SEIKO EPSON CORPORATION, TOKYO (JP)

(21) Appl. No.: 14/246,704

(22) Filed: Apr. 7, 2014

(30) Foreign Application Priority Data
Apr. 9, 2013 (JP) 2013-081027

(51) Int. Cl. G02B 5/20

(52) U.S. Cl. CPC G02B 5/20
USPC 359/885

(57) ABSTRACT

An electro-optical device that includes an opposing substrate main section which has a groove on a front surface side thereof, a first insulation film which is so disposed as to cover the front surface and part of which keeps a distance from slopes of the groove, a light blocking film disposed in the circumference of the pixel region, a second insulation film disposed so as to cover the first insulation film, a hole penetrating the first insulation film and the second insulation film, and a third insulation film which is disposed so as to cover the second insulation film and to close the hole.

### BACKGROUND

1. Technical Field

The present invention relates to electro-optical devices, electronic apparatuses including the stated electro-optical devices, and manufacturing methods for the stated electro-optical devices.

2. Related Art

As an electro-optical device, a transmissive active liquid crystal device that serves as an optical modulator (light valve) in a liquid crystal projector is well-known, for example. The stated liquid crystal device includes an element substrate provided with pixel electrodes, an opposing substrate provided with an opposing electrode, a liquid crystal layer sandwiched between the element substrate and the opposing substrate, and so on. The liquid crystal device includes an opening region that transmits light and a non-opening region that blocks light, and the light that enters the opening region is modulated and outputted as display light. A region where the display light is outputted is a display region.

For example, a liquid crystal device as follows is proposed. That is, the liquid crystal device includes a prism serving as a light reflecting unit in a non-opening region of an opposing substrate. The prism reflects light that enters the non-opening region toward an opening region so that the reflected light can be used as part of display light, thereby improving utilization efficiency of light (JP-A-2012-226069).

In JP-A-2012-226069, a groove having a V-shaped cross section elongated in an optical axis (depth direction) is formed in a quartz substrate that configures the opposing substrate; an opening portion of the groove is closed by a sealing member and a material having a lower refractive index than that of the quartz substrate (air layer) is confined to the interior of the groove. As a result, a prism with its slope being a light reflecting surface is formed. The quartz substrate in which such prism is formed includes a light blocking film, an insulation film, an opposing electrode, and an alignment layer that are laminated in series.

FIG. 15 is a schematic diagram illustrating behavior of light that enters the liquid crystal device described in JP-A-2012-226069. Note that in FIG. 15, an opposing electrode, pixel electrodes, the alignment layer, thin-film transistors, and so on are not illustrated in order to facilitate understanding of the behavior of light. In the drawing, reference symbol D4 represents a non-opening region (light blocking region) while reference symbol D3 represents an opening region (light transmitting region) where light is modulated.

As shown in FIG. 15, a liquid crystal device 1 includes an element substrate 80, an opposing substrate 90 that is disposed opposing the element substrate 80, and a liquid crystal layer 85 sandwiched between the element substrate 80 and the opposing substrate 90. A light blocking layer 81 is provided in the element substrate 80, and a region where the light blocking layer 81 is provided is the non-opening regions D4. In the opposing substrate 90, an opposing substrate main section 91, a light blocking film 96, and an insulation film 97 are laminated in that order. A prism 95 serving as a light reflecting unit is provided in the non-opening region D4 of the opposing substrate main section 91. The prism 95 is configured of a groove 92, a low refractive index layer 93 having a lower refractive index than that of the opposing substrate main section 91, and a sealing layer 94. The groove 92 has a slope 92a and a tip portion 92b, and the slope 92a serves as a light reflecting surface. The light blocking film 96 is also provided in frame form in the circumference of a display region so as to serve as a parting section of the display region (not illustrated).

Light emitted from a light source (not shown) travels (enters) in a direction extending from the opposing substrate 90 toward the element substrate 80. Light having entered the opposing substrate 90 passes through a surface 97a of the opposing substrate 90 provided on the side from which light is outputted, and enters the element substrate 80. Hereinafter, the surface 97a of the opposing substrate 90 provided on the side from which light is outputted is referred to as “output surface 97a”. Further, a normal direction with respect to the output surface 97a is an optical axis of a liquid crystal projector. The traveling direction of light emitted from the light source is determined by an F-number of a projection optical system in the liquid crystal projector. In the case where the F-number is 1.8, for example, an angle formed by the light emitted from the light source to enter the liquid crystal device 1 and the optical axis is 0 to 15.5 degrees.

In FIG. 15, light that travels in a direction intersecting with the optical axis is illustrated whereas light that travels in a direction along the optical axis is not illustrated. The light that travels in the direction intersecting with the optical axis so as to be display light includes light L3 that passes through the opening region D3 without being blocked by the prism 95 and light L4 that is reflected by the prism 95 and passes through the opening region. In the drawing, the light L3 is indicated by half-tone dot meshing while the light L4 is indicated by a broken line. Although not illustrated, the light that travels along the optical axis so as to be the display light likewise includes light that passes through the opening region D3 without being blocked by the prism 95 and light that is reflected by the prism 95 and passes through the opening region D3 as well.

Light that travels in a direction toward the non-opening region D4 is not used as display light in the case where the prism 95 is not formed, but used as display light by forming the prism 95. In other words, forming the prism 95 makes it possible to improve the utilization efficiency of light and realize bright display.

In FIG. 15, a region where the light L3 and the output surface 97a intersect with each other is an irradiation surface of the light L3. An irradiation surface area of the light L3 varies depending on the position of the tip portion 92a of the groove 92. For example, as the position of the tip portion 92b of the groove 92 is lowered, in other words, a distance between the tip portion 92b and the output surface 97a is shortened, the irradiation surface area of the light L3 becomes larger so that brightness of the light L3 becomes higher. There exists such a problem in JP-A-2012-226069 that it is difficult to shorten the distance between the tip portion 92b and the output surface 97a so as to make the brightness of the light L3 higher.

More specifically, between the tip portion 92b of the groove 92 and the output surface 97a, there are disposed the groove 92, the sealing layer 94, the light blocking film 96, and the insulation film 97, among which the light blocking film 96 can be provided only in the circumference of the display region as the parting section of the display region. Accordingly, the groove 92, the sealing layer 94, and the insulation film 97 at least need be disposed between the tip portion 92b of the groove 92 and the output surface 97a. The groove 92 and the sealing layer 94 are constituent elements of the prism 95, and the insulation film 97 is a constituent element for reducing influence of a step of the light blocking film 96; therefore it is difficult to make the shapes (dimensions) thereof smaller. In other words, because it is difficult to make the dimensions of the constituent elements disposed between the tip portion 92b of the groove 92 and the output surface 97a be smaller, there has been a problem in that it is difficult to shorten the distance between the tip portion 92b and the output surface 97a so as to make the brightness of the light L3 higher (realize brighter display).

### SUMMARY

An advantage of some aspects of the invention is to provide an electro-optical device, an electronic apparatus, and a manufacturing method for the stated electro-optical device, and the invention can be embodied in the following aspects or application examples.

### First Application Example

An electro-optical device according to a first application example is an electro-optical device that has a pixel region where a plurality of pixels are disposed, and that includes a substrate which has a groove on the side of a first surface thereof and transmits light, a first insulation film which is so disposed as to cover the first surface and part of which keeps a distance from a side surface of the groove, a light blocking film disposed in the circumference of the pixel region, a second insulation film disposed so as to cover the first insulation film, a hole which is formed penetrating the first insulation film and the second insulation film so as to communicate with the groove, and a third insulation film which is disposed so as to cover the second insulation film and to close the hole. Further, in the stated electro-optical device, the groove is disposed to overlap with a boundary between a first pixel among the plurality of pixels and a pixel adjacent to the first pixel, and the light blocking film is disposed between the first insulation film and the second insulation film.

In the electro-optical device according to this application example, the grooves are provided in the first surface of the substrate, and on the first surface of the substrate, the first insulation film, the second insulation film, and the third insulation film are laminated in series. The first insulation film, the second insulation film, and the third insulation film serve as a sealing layer that confines a material having a different refractive index than that of the substrate to the interior of the groove. The side surface of each of the grooves becomes an interface configured with materials having different refractive indices, and is light-reflective. In other words, a light reflecting unit is formed by the groove, the sealing layer (the first, second and third insulation films), and the material having such different refractive index. As a result, light that travels from the first surface of the substrate toward the third insulation film is reflected by the side surface of the groove so that the reflected light can be used as part of the light contributing to display operation (display light), whereby the utilization efficiency of light can be improved. The display light is configured with light that is reflected by the light reflecting unit (display light 1) and light that passes through the substrate without being reflected (blocked) by the light reflecting unit (display light 2). Brightness of the display light 1 is higher as the light reflecting surface (side surface of the groove) is wider. Since the display light 2 is light that is not blocked by the light reflecting surface, brightness of the display light 2 is higher as the dimension of the light reflecting unit (height of the light reflecting unit) is smaller. In other words, the brightness of the display light 2 is higher as the thickness of the sealing layer (the first, second and third insulation films) is thinner. The light blocking film is disposed between the first insulation film and the second insulation film and serves as a parting section that blocks light other than the display light. The light blocking film is disposed between the first insulation film and the second insulation film, and the influence of a step of the light blocking film is lessened by the second insulation film and the third insulation film. To rephrase, the light blocking film is disposed in the sealing layer and the influence of the step of the light blocking film is lessened by the constituent elements of the sealing layer. If the light blocking film is disposed on the sealing layer, an additional insulation film need be provided in order to lessen the influence of the step of the light blocking film. Providing the additional insulation film will make the height of the light reflecting unit larger, whereby the brightness of the display light 2 will be lowered in comparison with the configuration of this application example. Accordingly, the electro-optical device according to this application example has a configuration in which the light blocking film is disposed in the sealing layer so that the brightness of the display light 2 is higher and brighter display can be realized in comparison with the configuration in which the light blocking film is disposed on the sealing layer.

### Second Application Example

In the electro-optical device according to the above application example, it is preferable for the total thickness of the first insulation film, the second insulation film, and the third insulation film to be equal to or less than 2,400 nm.

As described above, the display light is configured with light that is reflected by the light reflecting unit (display light 1) and light that passes through the substrate without being reflected by the light reflecting unit (display light 2); the brightness of the display light 2 is higher as the dimension of the light reflecting unit (height of the light reflecting unit) is smaller. In other words, the brightness of the display light 2 is higher as the thickness of the sealing layer (the first, second and the third insulation films) is thinner. Therefore, in order to realize brighter display, it is preferable for the thickness of the sealing layer (the first, second and third insulation films) to be thinner. To be more specific, it is preferable for the total thickness of the first insulation film, the second insulation film, and the third insulation film to be equal to or less than 2,400 nm.

### Third Application Example

In the electro-optical device according to the above application examples, it is preferable for the thickness of the first insulation film to be equal to or less than 200 nm, for the thickness of the second insulation film to be equal to or less than 800 nm, and for the thickness of the third insulation film to be equal to or less than 1,400 nm.

As described above, the display light is configured with light that is reflected by the light reflecting unit (display light 1) and light that passes through the substrate without being reflected by the light reflecting unit (display light 2); the brightness of the display light 2 is higher as the dimension of the light reflecting unit (height of the light reflecting unit) is smaller. In other words, the brightness of the display light 2 is higher as the thickness of the sealing layer (the first, second and third insulation films) is thinner. Therefore, in order to realize brighter display, it is preferable for the thickness of the sealing layer (the first, second, and third films) to be thinner. To be more specific, it is preferable for the thickness of the first insulation film to be equal to or less than 200 nm, for the thickness of the second insulation film to be equal to or less than 800 nm, and for the thickness of the third insulation film to be equal to or less than 1,400 nm.

### Fourth Application Example

In the electro-optical device according to the above application examples, it is preferable for a surface of the third insulation film to be flat.

Light traveling from the first surface of the substrate toward the third insulation film is outputted from the surface of the third insulation film so as to be display light. In other words, the surface of the third insulation film is an output surface of light. Since a flattening process has been performed on the surface of the third insulation film so as to cause the surface of the third insulation film to be flattened, it is possible to suppress the light outputted from the surface of the third insulation film from being disordered (scattered).

### Fifth Application Example

In the electro-optical device according to the above application examples, it is preferable for the third insulation film to be covered with a fourth insulation film.

Light traveling from the first surface of the substrate toward the fourth insulation film is outputted from a surface of the fourth insulation film so as to be display light. In other words, the surface of the fourth insulation film is also an output surface of light. The flattening process has been performed on the surface of the third insulation film so as to cause the surface of the third insulation film to be flattened. However, there is a case where minute scratches are produced in the surface of the third insulation film due to the flattening process. Even if such minute scratches are produced in the surface of the third insulation film, influence of the minute scratches (unevenness) is lessened by covering the third insulation film with the fourth insulation film so that an even (smooth) surface can be provided. In other words, covering the surface of the third insulation film on which the flattening process has been performed with the fourth insulation film makes it possible to stably form a smooth surface, whereby the influence of minute scratches produced due to the flattening process is suppressed. Furthermore, since the surface of the fourth insulation film is smooth, it is possible to suppress the light outputted from the surface of the fourth insulation film from being disordered (scattered).

### Sixth Application Example

In the electro-optical device according to the above application examples, it is preferable for the groove to be disposed to overlap with a border of the aforementioned pixel region.

In the electro-optical device according to the above application examples, light traveling from the first surface of the substrate toward the third insulation film is reflected by the side surface of the groove and the reflected light is made to be part of the display light, thereby improving the utilization efficiency of light. In order to further improve the utilization efficiency of light, it is preferable for the grooves to be formed across the overall region where the pixels are disposed. In other words, it is preferable for the grooves to be disposed to overlap with the border of the pixel region as well as disposed to overlap with the boundary between the first pixel among the plurality of pixels and the pixel adjacent to the first pixel.

### Seventh Application Example

In the electro-optical device according to the above application examples, it is preferable for the light blocking film to be disposed to overlap with the border of the pixel region.

In the electro-optical device according to the above application examples, display at high contrast is realized by blocking light other than the display light with the light blocking film. By disposing the light blocking film so that the film overlaps with the pixel region in addition to disposing the light blocking film in the circumference of the pixel region, it is possible to block light other than the display light in the pixel region with certainty.

### Eighth Application Example

In the electro-optical device according to the above application examples, it is preferable for a portion between the side surface of the groove and the first insulation film to be filled with a material having a lower refractive index than that of the substrate.

In the case where the portion between the side surface of the groove and the first insulation film is filled with a material having a lower refractive index than that of the substrate, the side surface of the groove becomes an interface configured with the materials having different refractive indices and is favorably light-reflective.

### Ninth Application Example

An electronic apparatus according to a ninth application example includes the electro-optical device described in the above application examples.

The electronic apparatus according to this application example includes the electro-optical device described in the above application examples; the stated electro-optical device includes a groove servings as a light reflecting unit and is capable of providing brighter display. For example, it is possible to provide brighter display by applying the electro-optical device described in the above application examples to electronic apparatuses, such as a projection display apparatus, a projection head-up display (HUD), a direct-view head-mounted display (HMD), an electronic book, a personal computer, a digital still camera, a liquid crystal television, a viewfinder or monitor direct-view video recorder, a car navigation system, an information terminal apparatus such as a POS terminal, an electronic note book, and so on.

### Tenth Application Example

A manufacturing method for an electro-optical device according to a tenth application example is a manufacturing method for an electro-optical device having a pixel region where a plurality of pixels are disposed, and the method includes: forming grooves, in a first surface of a light transmitting substrate, that are so arranged as to overlap with a boundary between a first pixel among the plurality of pixels and a pixel adjacent to the first pixel as well as overlap with a border of the pixel region; filling an interior of each groove with a sacrifice film; forming a first insulation film that covers the first surface; forming a light blocking film that is positioned on the first insulation film and is arranged in a circumference of the pixel region; forming a second insulation film that covers the first insulation film and the light blocking film; forming a hole that penetrates the first insulation film and the second insulation film so as to reach the sacrifice film; forming a distance between a side surface of the groove and the first insulation film by removing the sacrifice film through the hole by etching; forming a third insulation film that covers the second insulation film and closes the hole; and performing a flattening process on a surface of the third insulation film.

In the manufacturing method for the electro-optical device according to this application example, grooves are formed in the first surface of the substrate, the interior of each groove is filled with a sacrifice film, and the first insulation film that covers the first surface is formed while the side surface of the groove being protected by the sacrifice film. Next, the light blocking film is formed on the first insulation film, thereafter the second insulation film that covers the first insulation film and the light blocking film is formed. Subsequently, such a hole is formed that penetrates the first and second insulation films and reaches the sacrifice film, and a distance (space) is formed between the side surface of the groove and the first insulation film by removing the sacrifice film through the hole by etching. As a result, the region which has been filled with the sacrifice film becomes a space of the groove, and the first insulation film is suppressed from adhering to the side surface of the groove, for example; accordingly, it is possible to form a desired space in a stable manner. Because the light blocking film is sandwiched (protected) between the first insulation film and the second insulation film, corrosion is suppressed in the removing process of the sacrifice film. Next, the third insulation film that closes the hole is formed. The hole is an opening portion of the groove. By making the hole smaller, it is possible to close the opening portion of the groove even if the thickness of the third insulation film is made to be thinner. In other words, it is possible to make the thickness of the sealing layer (the first, second and third insulation films) that seals the space of the groove thinner. A deposition atmosphere of the third insulation film (material having a lower refractive index than that of the substrate) is confined to the space in the forming (deposition) of the third insulation film. As a result, a light reflecting unit is configured with the groove, the sealing layer (the first, second and third insulation films), and the low refractive index material confined to the space. The flattening process is performed on the third insulation film in order for the third insulation film to have a flat surface. The surface of the third insulation film is an output surface of light, and it is possible to suppress the light outputted from the surface of the third insulation film from being disorder (scattered) by causing the surface of the third insulation film to be flattened.

Light traveling from the first surface of the substrate toward the third insulation film is reflected by the side surface of the groove to become part of light that contributes to display operation (display light), whereby the utilization efficiency of light is improved and brighter display can be realized. The display light is configured with light that is reflected by the light reflecting unit (display light 1) and light that passes through the substrate without being reflected by the light reflecting unit (display light 2). Brightness of the display light 1 is higher as the side surface of the groove is wider. Brightness of the display light 2 is higher as the dimension of the light reflecting unit (height of the light reflecting unit) is smaller. In other words, the brightness of the display light 2 is higher as the thickness of the sealing layer (the first, second, and third insulation films) is thinner. The light blocking film is formed between the first insulation film and the second insulation film, and the influence of a step of the light blocking film is lessened by the second insulation film and the third insulation film. To rephrase, the light blocking film is formed in the sealing layer and the influence of the step of the light blocking film is lessened by the constituent elements of the sealing layer. If the light blocking film is formed on the sealing layer, an additional insulation film need be provided in order to lessen the influence of the step of the light blocking film. Providing the additional insulation film will make the height of the light reflecting unit larger, whereby the brightness of the display light 2 will be lowered. Accordingly, the electro-optical device according to this application example has a configuration in which the light blocking film is disposed in the sealing layer so that the brightness of the display light 2 is higher and brighter display can be provided in comparison with a configuration in which the light blocking film is disposed on the sealing layer.

### Eleventh Application Example

In the manufacturing method for the electro-optical device according to the above application example, it is preferable for the performing of the flattening process on the surface of the third insulation film to include polishing and etching a polished surface after the polishing.

The performing of the flattening process on the surface of the third insulation film according to the above application example includes polishing and etching the polished surface after the polishing. Minute scratches produced in the polishing are reduced by the etching of the polished surface that has experienced the polishing. Accordingly, influence of the minute scratches (unevenness) is lessened in the surface of the third insulation film so that the third insulation film can have an even (smooth) surface. Further, since the surface of the third insulation film becomes smooth, it is possible to suppress the light outputted from the surface of the third insulation film from being disordered (scattered).

### BRIEF DESCRIPTION OF THE DRAWINGS

The invention will be described with reference to the accompanying drawings, wherein like numbers reference like elements.

FIG. 1 is a schematic plan view illustrating a configuration of a liquid crystal device according to a first embodiment.

FIG. 2 is a schematic cross-sectional view of the liquid crystal device taken along a line II-II in FIG. 1.

FIG. 3 is an equivalent circuit diagram illustrating an electric configuration of the liquid crystal device according to the first embodiment.

FIG. 4 is a schematic plan view illustrating arrangement of pixel electrodes of the liquid crystal device according to the first embodiment.

FIG. 5 is a schematic plan view illustrating an arrangement state of grooves of the liquid crystal device according to the first embodiment.

FIG. 6 is a schematic plan view illustrating an arrangement state of a light blocking film of the liquid crystal device according to the first embodiment.

FIG. 7 is a schematic cross-sectional view of the liquid crystal device taken along a line VII-VII in FIG. 4.

FIG. 8 is a graph illustrating a relationship between pixel dimensions and efficiency.

FIG. 9 is a process flowchart illustrating a manufacturing method for an opposing substrate.

FIGS. 10A through 10D are schematic cross-sectional views illustrating a manufacturing method for the opposing substrate.

FIGS. 11A through 11D are schematic cross-sectional views illustrating the manufacturing method for the opposing substrate.

FIG. 12 is a schematic cross-sectional view illustrating the manufacturing method for the opposing substrate.

FIG. 13 is a schematic cross-sectional view of a liquid crystal device according to a second embodiment.

FIG. 14 is a schematic view illustrating a configuration of a projection display apparatus according to a third embodiment.

FIG. 15 is a schematic diagram illustrating behavior of light that enters the liquid crystal device described in JP-A-2012-226069.

### DESCRIPTION OF EXEMPLARY EMBODIMENTS

Hereinafter, specific embodiments of the invention will be described with reference to the drawings. Note that the following embodiments only give some examples of the invention and the invention is not intended to be limited thereto, and many variations can be arbitrarily made thereon without departing from the technical spirit and scope of the invention. Further, the drawings used here illustrate the layers and areas being described in an enlarged or reduced manner so that those layers and areas can be recognized properly.

### First Embodiment

### Overview of Liquid Crystal Device

A liquid crystal device 100 according to a first embodiment is an example of an electro-optical device, and is a transmissive liquid crystal device including thin-film transistors (hereinafter, called “TFTs”) 30. The liquid crystal device 100 according to this embodiment is a device that can be favorably used as an optical modulator of a projection display apparatus (liquid crystal projector) to be explained later, for example.

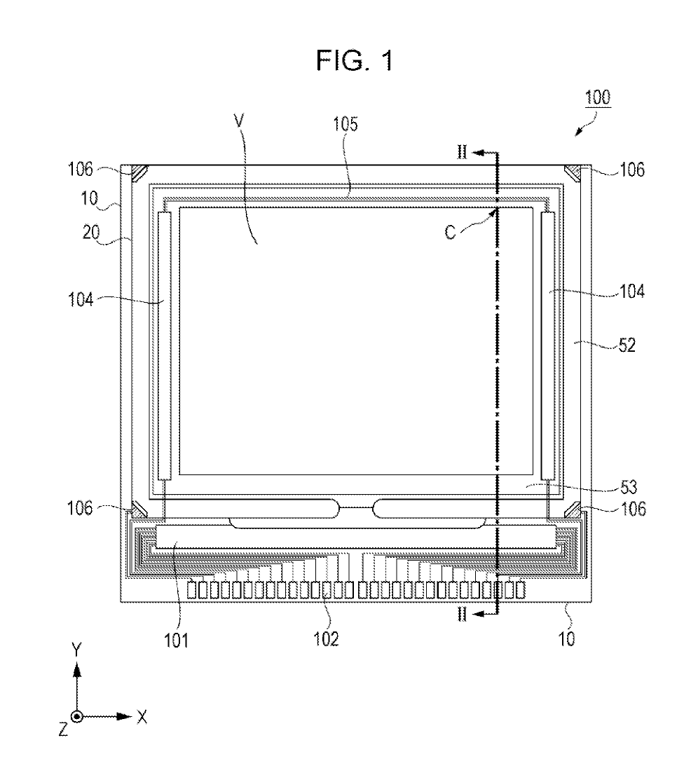

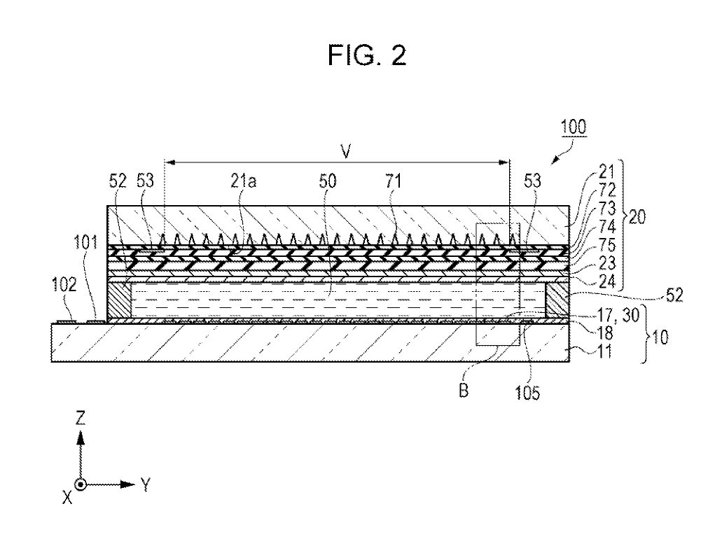

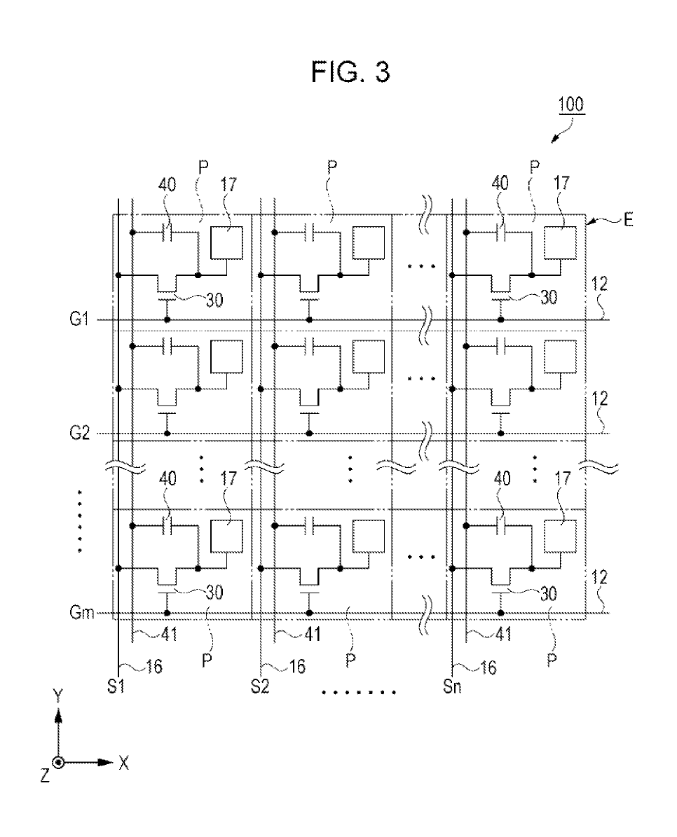

First, the overall configuration of the liquid crystal device 100 according to this embodiment will be described with reference to FIGS. 1 through 3. FIG. 1 is a schematic plan view illustrating a configuration of the liquid crystal device. FIG. 2 is a schematic cross-sectional view of the liquid crystal device taken along a line II-II in FIG. 1. FIG. 3 is an equivalent circuit diagram illustrating an electric configuration of the liquid crystal device. In FIG. 3, a region enclosed by double-dot dash lines corresponds to a pixel P.

As shown in FIGS. 1 and 2, the liquid crystal device 100 according to this embodiment includes an element substrate 10, and an opposing substrate 20, a liquid crystal layer 50 sandwiched between the element substrate 10 and the opposing substrate 20, and so on.

The element substrate 10 is larger in size than the opposing substrate 20; these two substrates are attached to each other with a seal member 52 that is disposed therebetween in frame form when seen from above, and liquid crystal having positive or negative dielectric anisotropy is injected into a space between the two substrates to constitute a liquid crystal layer 50. As the seal member 52, an adhesive such as thermosetting epoxy resin, ultraviolet curing epoxy resin, or the like is adopted, for example. A spacer for ensuring a constant distance between the element substrate 10 and the opposing substrate 20 is mixed in the seal member 52 (not shown).

A light blocking film 53 is provided also in frame form at the inside of the seal member 52 disposed in frame form. The light blocking film 53 is made of metal or metal oxide having a light blocking property; a region enclosed by the light blocking film 53 is a display region V.

A data line driving circuit 101 is provided between a first side where a plurality of external connection terminals 102 of the element substrate 10 are arranged and the seal member 52 extending along the first side. Scanning line driving circuits 104 are provided between the seal member 52 extending along a second side and the region V, and between the seal member 52 extending along a third side and the display region V, respectively; the second side and the third side oppose each other and are both orthogonal to the first side. A plurality of interconnects 105 for connecting the two scanning line driving circuits 104 to each other are provided between the display region V and the seal member 52 extending along a fourth side opposing the first side. The interconnects that are connected with the data line driving circuit 101, the scanning line driving circuits 104, and the like are connected with the plurality of external connection terminals 102.

Hereinafter, a direction along the first side is taken as an X direction, a direction along other two sides orthogonal to the first side and opposing each other (second side, third side) is taken as a Y direction, a direction extending from the element substrate 10 toward the opposing substrate 20 is takes as a Z direction, and a direction extending from the opposing substrate 20 toward the element substrate 10 is taken as a Z (−) direction in the descriptions given below.

As shown in FIG. 2, the element substrate 10 includes an element substrate main section 11, and also includes the TFTs 30 and pixel electrodes 17 formed on a surface of the element substrate main section 11 on the liquid crystal layer 50 side, an alignment layer 18 that covers the pixel electrodes 17, and the like. The element substrate main section 11 is configured with a transparent substrate such as a quartz substrate, a glass substrate, or the like, for example.

Details of the element substrate 10 will be described later.

The opposing substrate 20 includes an opposing substrate main section 21, and also includes a first insulation film 72, a light blocking film 53, a second insulation film 73, a third insulation film 74, a fourth insulation film 75, an opposing electrode 23, an alignment layer 24, and so on that are laminated in series on a surface 21a of the opposing substrate main section 21 on the liquid crystal layer 50 side.

A quartz substrate, for example, is used in the opposing substrate main section 21. It is sufficient that the opposing substrate main section 21 is a light-transmissive insulation substrate whose major component is silicon oxide; accordingly, a glass substrate or the like aside from the quartz substrate can be used. Grooves 71 are formed in the surface 21a of the opposing substrate main section 21 on the liquid crystal layer 50 side.

The opposing substrate main section 21 is an example of a “light transmitting substrate” of this invention. The surface 21a of the opposing substrate main section 21 on the liquid crystal layer 50 side is an example of a “first surface” of this invention. Hereinafter, the surface 21a of the opposing substrate main section 21 on the liquid crystal layer 50 side is referred to as “front surface 21a”.

The first insulation film 72, the second insulation film 73, the third insulation film 74, and the fourth insulation film 75 are each configured with a light-transmissive inorganic insulation material, and such silicon oxide can be used that is formed by using, for example, a plasma Chemical Vapor Deposition (CVD) technique or the like.

The light blocking film 53 is configured with titanium nitride, for example, and has a light blocking property. As shown in FIG. 1, the light blocking film 53 is provided in frame form at a location overlapping with the scanning line driving circuits 104 when seen from above. With this, light that enters the element substrate 10 side from the opposing substrate 20 side is blocked so that operation failure of the scanning line driving circuits 104 is prevented from occurring due to the light.

The opposing electrode 23 is configured with a transparent conductive layer such as indium tin oxide (ITO) or the like, and is formed across the display region V. As shown in FIG. 1, the opposing electrode 23 is electrically connected with interconnects at the element substrate 10 side (not shown) by conductive through-holes 106 provided in the four corners of the opposing substrate 20.

The alignment layer 18 that covers the pixel electrodes 17 and the alignment layer 24 that covers the opposing electrode 23 are set based on optical design of the liquid crystal device 100, and an oblique vapor deposition film (inorganic alignment layer) of inorganic material such as silicon oxide or the like is used in this embodiment. Further, an organic alignment layer of polyimide or the like may be used for the alignment layers 18 and 24.

As shown in FIG. 3, the pixels P are disposed in matrix form along the X direction and the Y direction so as to configure a pixel region E. A double-dot dash line arranged at the outermost circumference of the pixel region E corresponds to a border of the pixel region E. Although not illustrated in FIG. 3, the display region V is disposed within the pixel region E.

The pixel region E includes a plurality of scanning lines 12 and a plurality of data lines 16; the scanning lines 12 and the data lines 16 serve as signal lines and are insulated from each other. The pixel region E further includes capacitor lines 41 extending in parallel with the data lines 16, and the like. Arrangement of the capacitor lines 41 is not limited to the above-described arrangement, that is, the capacitor lines 41 may be arranged so as to extend in parallel with the scanning lines 12.

The signal lines such as the scanning lines 12, the data lines 16, the capacitor lines 41, and the like are configured with light blocking conductive materials, and provided at the element substrate 10 side so as to serve as the constituent elements of the pixels. In each of regions defined by the scanning lines 12 and the data lines 16, the pixel electrode 17, the TFT 30, a storage capacitor 40, and the like are provided so as to configure a pixel circuit of the pixel P.

The scanning line 12 is electrically connected with a gate electrode of the TFT 30. The data line 16 is electrically connected with a source electrode of the TFT 30. The pixel electrode 17 is electrically connected with a drain electrode of the TFT 30.

The data lines 16 are connected with the data line driving circuit 101 (see FIG. 1) and supply the pixels P with image signals S1, S2, . . . , Sn supplied from the data line driving circuit 101. The scanning lines 12 are connected with the scanning line driving circuits 104 (see FIG. 1) and supply the pixels P with scanning signals G1, G2, . . . , Gm supplied from the scanning line driving circuits 104. The image signals S1, S2, . . . , Sn supplied from the data line driving circuit 101 to the data lines 16 may be line-sequentially supplied in this order, or may be supplied to the data lines 16 in groups each of which includes a plurality of data lines 16 adjacent to each other.

The liquid crystal device 100 is configured so that the image signals S1, S2, . . . , Sn provided from the data lines 16 are written into the pixel electrodes 17 via the TFTs 30 in synchronization with a period during which the TFTs 30, serving as switching elements, are made to be ON due to input of the scanning signals G1, G2, . . . , Gn. Then, the image signals S1, S2, . . . , Sn having been written into the pixel electrodes 17 at a predetermined level are held for a set period of time between the pixel electrodes 17 and the opposing electrode 23 that functions as the opposing electrode.

In order to prevent the image signals S1, S2, . . . , Sn being held from being leaked (deteriorated), the storage capacitors 40 are connected in parallel with liquid crystal capacitance formed between the respective pixel electrodes 17 and the opposing electrode 23. Each storage capacitor 40 is provided between the drain electrode of the TFT 30 and the capacitor line 41.

The above liquid crystal device 100 is a transmissive type in which such optical design is employed that has the normally white mode, the normally black mode, and the like. In the normally white mode, transmittance of the pixel P at a time when a voltage is not applied is larger than that at a time when the voltage is applied so that bright display is given; whereas in the normally black mode, the transmittance of the pixel P at the time when the voltage is not applied is smaller than that at the time when the voltage is applied so that dark display is given. Based on the optical design, polarization elements are disposed on the entering side of light and the output side of light, respectively (not shown).

### Arrangement of Grooves and Light Blocking Film

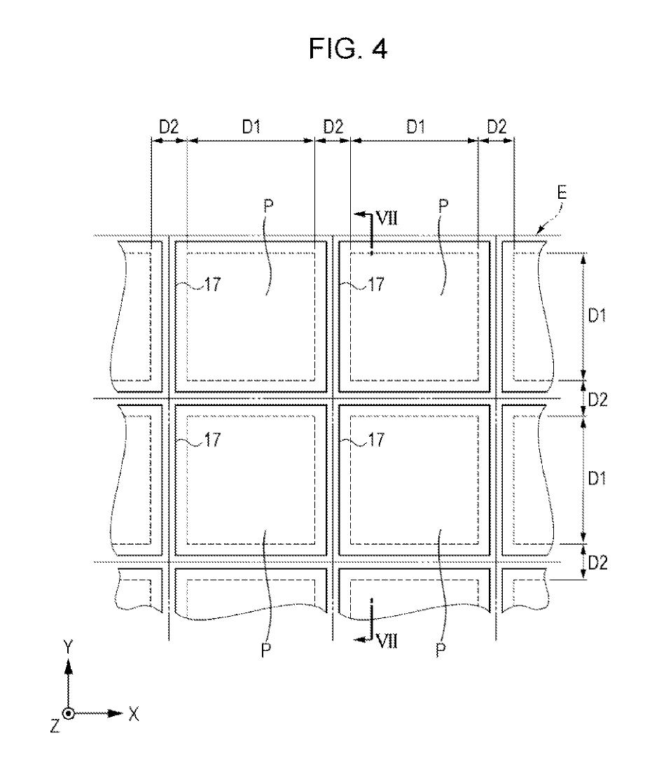

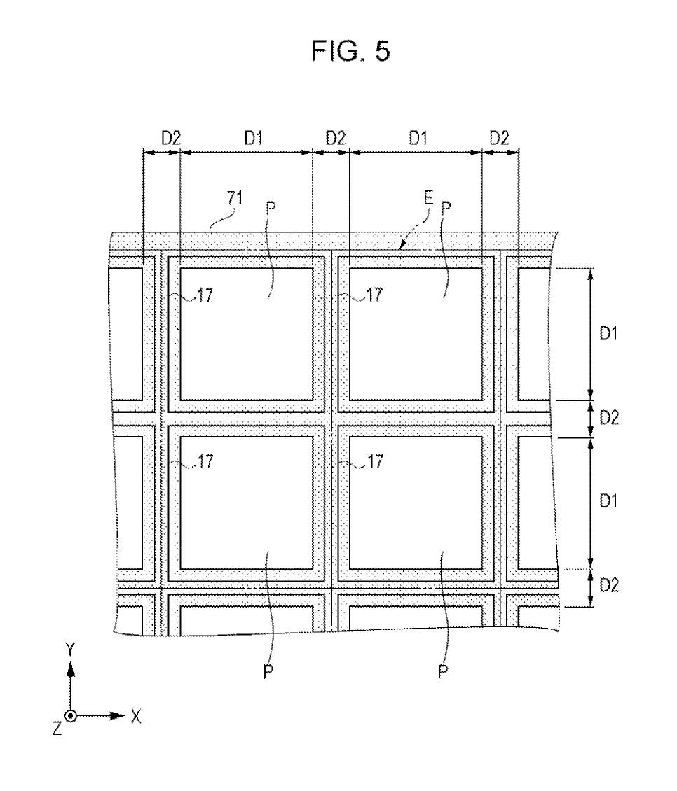

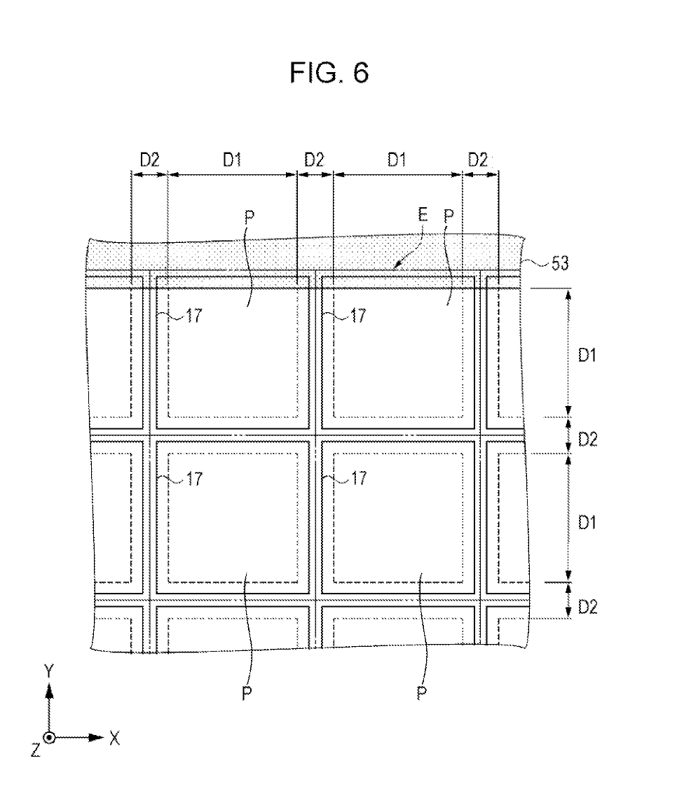

FIG. 4 is a schematic plan view illustrating an arrangement state of the pixel electrodes corresponding to a portion where the line II-II indicated by an arrow C in FIG. 1 and the border of the light blocking film 53 intersect with each other. FIG. 4 corresponds to a portion B enclosed by a double-dot dash line in FIG. 2; therefore, FIG. 4 is also a plan view schematically illustrating the portion B in FIG. 2 when seen from the Z direction. In FIG. 4, the pixel electrodes 17 are illustrated with a solid line, and other constituent elements are not illustrated. FIG. 5 is a view corresponding to FIG. 4, and is a schematic plan view illustrating an arrangement state of the grooves. In FIG. 5, the grooves are illustrated with half-tone dot meshing. FIG. 6 is a view corresponding to FIG. 4, and specifically is a schematic plan view illustrating an arrangement state of the light blocking film. In FIG. 6, the light blocking film is illustrated with half-tone dot meshing.

In FIGS. 4 through 6, regions enclosed by double-dot dash lines are the pixels P, while regions enclosed by broken lines are opening regions D1 that transmit light. Light that passes through the opening region D1 is modulated to become display light. A region between the opening region D1 and its adjacent opening region D1 is a non-opening region D2 (light blocking region). In the non-opening region D2, there are disposed light blocking materials configured of the signal lines (data line 16, scanning line 12, capacitor line 41) and the like. To rephrase, a light blocking region where the light blocking materials such as the signal lines are disposed is the non-opening region D2, while a region enclosed by the non-opening regions D2 is the opening region D1 that transmits (modulates) light.

As shown in FIG. 4, the opening region D1 is substantially square in shape, that is, dimension of the opening region D1 in the X direction and dimension thereof in the Y direction are set to be the same. Dimension of the non-opening region D2 in the X direction and dimension thereof in the Y direction are also set to be the same.

The pixels P have an approximately square shape and are disposed in matrix form in the X and Y directions to form the pixel region E. As described above, in each of the pixels P, there are disposed the pixel electrode 17, the TFT 30, the storage capacitor 40, the scanning line 12, the data line 16, the capacitor line 41, and the like. A double-dot dash line arranged uppermost in the drawing and extended along the X direction corresponds to the border of the pixel region E. Other double-dot dash lines correspond to the boundaries between the plurality of disposed pixels P and the adjacent pixels thereof (hereinafter, called “boundaries of the pixels P”). Likewise in FIG. 5 and FIG. 6, a double-dot dash line arranged uppermost in each drawing corresponds to the border of the pixel region E, and other double-dot dash lines in the drawing correspond to the boundaries of the pixels P.

The pixel electrode 17 has an approximately square shape and is disposed inside the pixel P. An outer edge portion of the pixel electrode 17 is disposed so as to overlap with the non-opening region D2 or the light blocking film 53 (see FIG. 6) when seen from the Z direction.

First, the regions where the grooves 71 are disposed will be described with reference to FIG. 5.

As shown in FIG. 5, the grooves 71 are provided in lattice form overlapping with the non-opening regions D2 and extending in the X direction and the Y direction when seen from the Z direction. To rephrase, the grooves 71 are disposed so as to overlap with the boundaries of the pixels P. Further, the grooves 71 are disposed so as to overlap with the border of the pixel region E.

Next, the regions where the light blocking film 53 is disposed will be described with reference to FIG. 6.

As shown in FIG. 6, the light blocking film 53 is disposed overlapping with the circumference of the pixel region E and the border of the pixel region E. Accordingly, the outer edge portion of the light blocking film 53 is disposed overlapping with the pixel region E.

As described above, the light blocking film 53 is shaped in frame form and a region enclosed by the light blocking film 53 is the display region V (see FIG. 1) where an image is displayed. The light blocking film 53 serves as a parting section of the display region V and blocks light so as to prevent unnecessary light from entering into the display region V, thereby realizing high contrast display. Note that the opening regions D1 are disposed in the regions enclosed by the light blocking film 53.

For example, such a configuration may be employed that the light blocking film 53 is disposed only in the circumference of the pixel region E, in which a light blocking material disposed at the element substrate 10 side (capacitor line 41, for example) forms a light blocking film as the parting section of the display region V and the light blocking film 53 is disposed so as to overlap with the above-formed light blocking film when seen from the Z direction. In other words, the light blocking film 53 may have a configuration in which the film is disposed in the circumference of the pixel region E as well as the border of the pixel region E or have a configuration in which the film is disposed in the circumference of the pixel region E.

### Overview of Element Substrate and Opposing Substrate

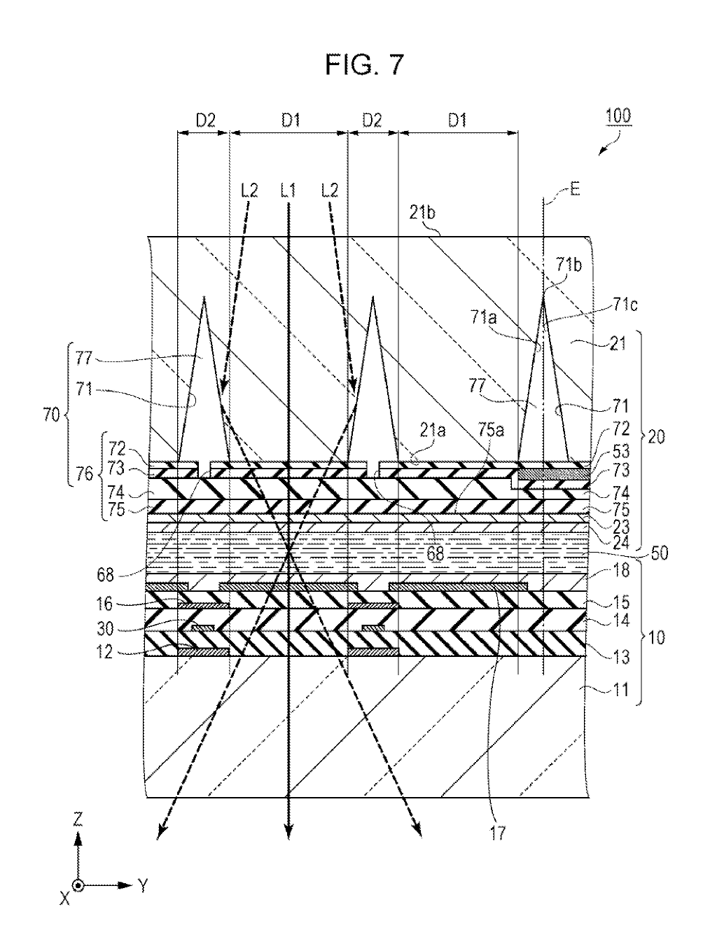

FIG. 7 is a schematic cross-sectional view of the liquid crystal device taken along a line VII-VII in FIG. 4. A double-dot dash line in FIG. 7 represents the border of the pixel region E. Arrows to which reference symbols L1 and L2 are respectively assigned represent beams of light that are emitted from a light source (not shown), enter the opposing substrate 20 side, and are outputted to the element substrate 10 side as display light. Light L2 is light that enters toward the non-opening region D2, while light L1 is light that enters toward the opening region D1. The liquid crystal device 100 of this embodiment is an optical modulator (light valve) that can be favorably used in a liquid crystal projector to be explained later, and the Z axis corresponds to an optical axis of the liquid crystal projector. The F-number of a projection optical system in the liquid crystal projector to be explained later is approximately 1.8, for example, and the angle formed by the optical axis and the light that is emitted from the light source and enters the liquid crystal device 100 is 0 to 15.5 degrees.

First, the overview of the element substrate 10 will be described with reference to FIG. 7.

As shown in FIG. 7, the element substrate 10 includes the element substrate main section 11, and also includes the scanning lines 12, a first insulation layer 13, the TFTs 30, a second insulation layer 14, the data lines 16, a third insulation layer 15, the pixel electrodes 17, the alignment layer 18, and the like that are laminated in series on the surface of the element substrate main section 11 on the liquid crystal layer 50 side.

The scanning line 12 is formed of, for example, metal such as aluminum (Al), molybdenum (Mo), tungsten (W), titanium (Ti), or chromium (Cr); an alloy including at least one of these metals; metal silicide; poly-silicide; nitride; or a member in which the above materials are laminated. Note that the scanning line 12 has a light blocking property.

The first insulation layer 13 is provided so as to cover the element substrate main section 11 and the scanning lines 12. The first insulation layer 13 is configured with, for example, silicon oxide, and is light-transmissive. The TFTs 30 are provided on the first insulation layer 13. The TFTs 30 are a switching element that drives the pixel electrode 17. Although not illustrated, each of the TFTs 30 is configured with a semiconductor layer, a gate electrode, a source electrode, a drain electrode, and the like.

The semiconductor layer is made of, for example, a poly-crystal silicon film and formed in an island. Impurity ions are injected into the semiconductor layer to form a source region, a channel region, and a drain region. A lightly doped drain (LDD) region may be formed between the channel region and the source region or between the channel region and the drain region.

The gate electrode is disposed in a region overlapping with the channel region of the semiconductor layer via part of the second insulation layer 14 (gate insulation film) when seen from the Z direction. Although not illustrated, the gate electrode is electrically connected with the scanning line 12, which is disposed on a lower layer side, via a contact hole.

The second insulation layer 14 is provided so as to cover the first insulation layer 13 and the TFTs 30. The second insulation layer 14 is configured with silicon oxide, for example, and is light-transmissive. The second insulation layer 14 includes the gate insulation film that ensures electrical insulation between the semiconductor layer of the TFT 30 and the gate electrode. The second insulation layer 14 reduces unevenness caused by the TFT 30.

The data lines 16 are provided on the second insulation layer 14. The data line 16 is configured with the same material as the scanning line 12 and has a light blocking property. The TFT 30 is disposed so as to be sandwiched between the light-blocking scanning line 12 and data line 16. This suppresses an increase in leak current (operation failure of the TFT 30) due to the light entering into the semiconductor layer of the TFT 30.

Although not illustrated, on the second insulation layer 14, the capacitor line 41 is provided in a different interconnect layer from that of the data line 16. The third insulation layer 15 is provided so as to cover the second insulation layer 14, the data line 16, and the capacitor line 41. The third insulation layer 15 is configured with silicon oxide, for example, and is light-transmissive.

The pixel electrodes 17 are provided on the third insulation layer 15. The pixel electrode 17 is electrically connected with the drain region in the semiconductor layer of the TFT 30 via contact holes (not shown) provided in the second insulation layer 14, the third insulation layer 15, and the like. The alignment layer 18 is provided so as to cover the pixel electrodes 17.

Next, the overview of the opposing substrate 20 will be described with reference to FIG. 7.

The opposing substrate 20 includes the opposing substrate main section 21, and also includes the first insulation film 72, the light blocking film 53, the second insulation film 73, the third insulation film 74, the fourth insulation film 75, the opposing electrode 23, the alignment layer 75, and the like that are laminated in series on the front surface 21a of the opposing substrate main section 21. The first insulation film 72, the second insulation film 73, the third insulation film 74, and the fourth insulation film 75 configure a sealing layer 76. Note that in the following description, a surface opposing the front surface 21a of the opposing substrate main section 21 is referred to as a rear surface 21b.

As described earlier, the opposing substrate main section 21 is formed of a quartz substrate; the first insulation film 72, the second insulation film 73, the third insulation film 74, and the fourth insulation film 75 are each formed of silicon oxide. These constituent elements have the same refractive index so that light is not attenuated at interfaces between these constituent elements due to the reflection of light or the like. Accordingly, the interfaces between these constituent elements allow the light to pass therethrough in a favorable manner.

The grooves 71 are provided in the opposing substrate main section 21. As described earlier, the grooves 71 are disposed so as to overlap with the boundaries of the pixels P as well as overlap with the border of the pixel region E. The groove 71 disposed on the boundary between the pixels P and the groove 71 disposed on the border of the pixel region E have the same cross section in shape when seen from the X and Y directions, and are formed in a lattice pattern when seen from the Z direction and connected with one another (see FIG. 5).

The grooves 71 are formed in the front surface 21a of the opposing substrate main section 21 by etching the opposing substrate main section 21 in the Z direction. Each groove 71 is shaped in a V form, when seen from the X direction, that spreads outward as it progresses along a direction from the rear surface 21b of the opposing substrate toward the front surface 21a of the opposing substrate main section 21 (Z (−) direction). To be more specific, the groove 71 has slopes 71a and 71c that intersect with the Z direction; the slopes 71a and 71b meet each other toward the Z direction side and form a tip portion 71b along the X direction. Dimension of the groove 71, in the Y direction, of the opposing substrate main section 21 on the front surface 21a side (opening dimension) is approximately 1,000 nm to 2,000 nm. Dimension of the groove 71 in the Z direction (depth) is approximately 30,000 nm to 35,000 nm. An angle formed by the slopes 71a, 71c and the Z direction is equal to or less than 3 degrees.

The first insulation film 72 is so disposed as to cover the front surface 21a of the opposing substrate main section 21 and to cause part of the first insulation film 72 to keep a distance from the slopes 71a, 71c (side surface) of the groove 71. Thickness of the first insulation film 72 is approximately 200 nm. The first insulation film 72 is a constituent element of the sealing layer 76 and it is preferable for the thickness thereof to be thinner. More specifically, it is preferable for the thickness of the first insulation film 72 to be equal to or less than 200 nm.

The second insulation film 73 is disposed so as to cover the first insulation film 72. Thickness of the second insulation film 73 is approximately 600 nm to 800 nm. The second insulation film 73 is a constituent element of the sealing layer 76 and it is preferable for the thickness thereof to be thinner. More specifically, it is preferable for the thickness of the second insulation film 73 to be equal to or less than 800 nm.

In the first insulation film 71 and the second insulation film 73, there are provided holes 68 that penetrate the first insulation film 71 and the second insulation film 73 so as to communicate with the grooves 71. The holes 68 are provided for each of the pixels P and arranged so as to overlap with the boundaries between the pixels P. The groove 71 that is so disposed as to overlap with the border of the pixel region E does not have the hole 68. It is preferable for the hole 68 to be smaller, and the diameter of the hole 68 is approximately equal to or less than 800 nm.

The third insulation film 74 is disposed so as to cover the second insulation film 73. The holes 68 that penetrate the first insulation film 72 and the second insulation film 73 are closed with the third insulation film 74 (sealed). Thickness of the third insulation film 74 is approximately 1,100 nm to 1,400 nm. The third insulation film 74 is a constituent element of the sealing layer 76 and it is preferable for the thickness thereof to be thinner. More specifically, it is preferable for the thickness of the third insulation film 74 to be equal to or less than 1,400 nm.

The fourth insulation film 75 is disposed so as to cover the third insulation film 74. Thickness of the fourth insulation film 75 is approximately 100 nm to 200 nm. The fourth insulation film 75 is a constituent element of the sealing layer 76 and it is preferable for the thickness thereof to be thinner. More specifically, it is preferable for the thickness of the fourth insulation film 75 to be equal to or less than 200 nm.

In a region enclosed by the groove 71 and the first insulation film 72, there is disposed a material (air layer 77) whose refractive index is smaller than that of the constituent material of the opposing substrate main section 21 (quartz).

The slopes 71a and 71c of the groove 71 form an interface between the materials having different refractive indices (opposing substrate main section 21, air layer 77), and the stated interface is light-reflective. As a result, the light L2 that travels toward the non-opening region D2 reflects off the slopes 71a, 71c of the groove 71, passes through the opening region D1, and is outputted in the Z (−) direction as display light. The light L1 that travels toward the opening region D1 passes through the opening region D1 and are outputted into the Z (−) direction as the display light. By providing the grooves 71, it is possible to use the light L2 that travels toward the non-opening region D2 as display light aside from the light L1 that travels toward the opening region D1, whereby the utilization efficiency of light can be improved in comparison with a case where the grooves 71 are not formed. In the manner described above, there is formed a prism 70 as a light reflecting unit that is configured of the groove 71, the air layer 77, and the sealing layer 76 (first insulation film 72, second insulation film 73, third insulation film 74, fourth insulation film 75) in the opposing substrate 20.

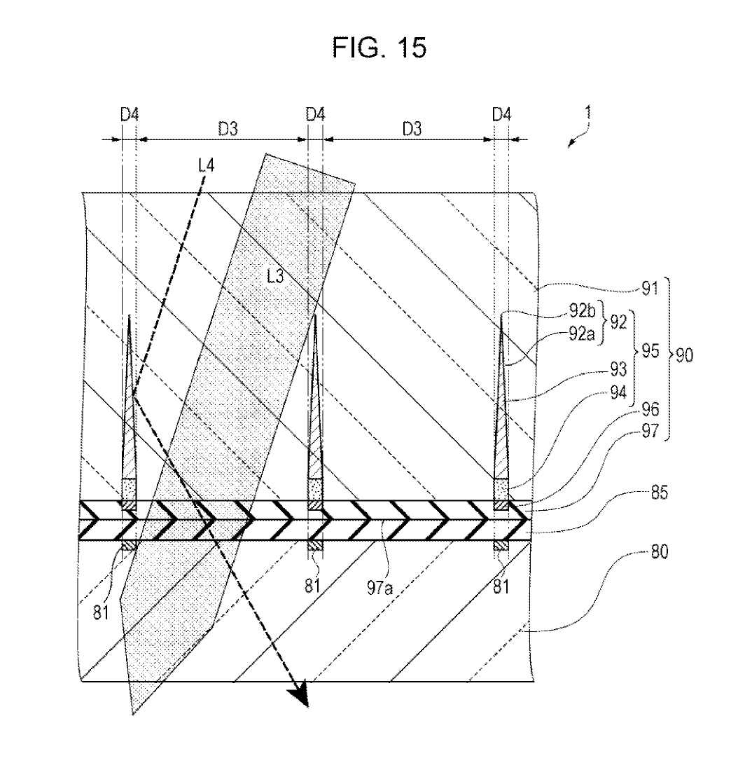

FIG. 15 is a schematic cross-sectional view of the opposing substrate 90 according to a known technique (JP-A-2012-226069). As described earlier, as the distance between the tip portion 92b of the groove 92 and the output surface 97a of light is shortened, the brightness of the light L3 that passes through the opening region D3 without being blocked by the light reflecting unit becomes higher. This embodiment has a configuration in which a distance between the tip portion of a groove and an output surface of light can be shortened in comparison with the configuration of the known technique. The detailed description is given below.

In the known technique, the light blocking film 96 and the insulation film 97 are disposed between the prism 95 and the output surface 97a. As described earlier, because it is possible for the light blocking film 96 to be disposed only in the circumference of the display region as a parting section of the display region, the light blocking film 96 need not be provided between the prism 95 and the output surface 97a. The insulation film 97 is difficult to be omitted because it has a function to lessen the influence of the step of the light blocking film 96. Accordingly, it is necessary to dispose at least the insulation film 97 between the prism 95 and the output surface 97a. In the following description, the configuration in which the insulation film 97 is disposed between the prism 95 and the output surface 97a is considered to be the known technique.

A surface 75a of the fourth insulation film 75 on the liquid crystal layer 50 side in this embodiment (see FIG. 7) corresponds to the output surface 97a (see FIG. 15) in the known technique, and hereinafter referred to as “output surface 75a”. One of differences between this embodiment and the known technique is a difference in positions where the light blocking films 53 and 96 are formed. In this embodiment, the light blocking film 53 is formed between the first insulation film 72 and the second insulation film 73. In other words, the light blocking film 53 of this embodiment is formed in the sealing layer 76 that is configured of the first insulation film 72, the second insulation film 73, the third insulation film 74, and the fourth insulation film 75. Meanwhile, the light blocking film 96 of the known technique is formed on the sealing layer 94. This point is one of the differences between this embodiment and the known technique.

The influence of the step of the light blocking film 53 in this embodiment is lessened by the third insulation film 74 and the fourth insulation film 75 that configure the sealing layer 76. The influence of the step of the light blocking film 96 in the known technique is lessened by the insulation film 97 that is formed separately from the sealing layer 94. Accordingly, in this embodiment, it is unnecessary to provide an insulation film that is formed separately from the sealing layer 76 in order to lessen the influence of the step of the light blocking film 53. This is a different point between this embodiment and the known technique.

The thickness of the insulation film 97 of the known technique is approximately 600 nm, whereas in this embodiment, it is unnecessary to provide the insulation film 97, which is approximately 600 nm thick. In addition, through optimizing the process conditions, the sealing layer 76 of this embodiment is thinner than the sealing layer 94 of the known technique by approximately 300 nm. More specifically, the thickness of the sealing layer 76 of this embodiment is approximately 2,600 nm, while the thickness of the sealing layer 94 of the known technique is approximately 2,900 nm. To rephrase, in this embodiment, there is disposed the insulation layer (sealing layer 76) with the thickness of approximately 2,600 nm between the air layer 77 and the output surface 75a. In the known technique, there is disposed the insulation layer with the thickness of approximately 3,500 nm (sealing layer 94, insulation film 97) between an air layer 93 and the output surface 97a. As a result, the dimension between the tip portion 71b of the groove 71 and the output surface 75a in this embodiment is shorter than the dimension between tip portion 92b of the groove 92 and the output surface 97a in the known technique by approximately 900 nm. As described above, the configuration of this embodiment is such that a distance between the tip portion of the groove and the output surface is shorter than that in the configuration of the known technique.

### Efficiency of Opposing Substrate

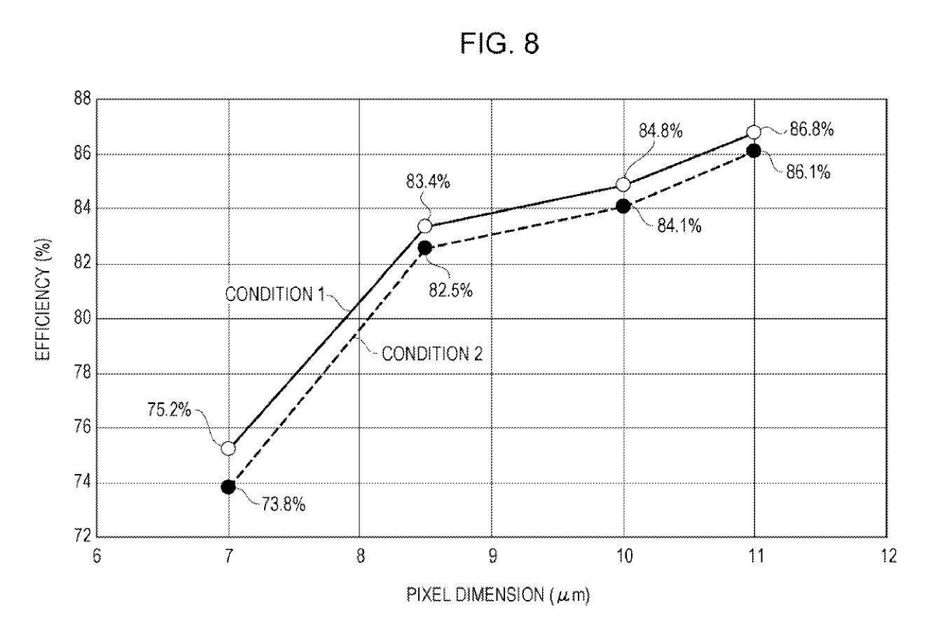

FIG. 8 is a graph illustrating a relationship between pixel dimensions and efficiency. In the graph, the horizontal axis represents dimension of the pixel P and the vertical axis represents efficiency. The efficiency here is an index indicating the rate of the brightness of light outputted from a surface of the opposing electrode 23 on the liquid crystal layer 50 side to the brightness of light entering into the rear surface 21b side of the opposing substrate main section 21. The efficiency can be obtained using an optical simulation in the case where the dimension of the pixel P is set to 7 μm, 8.5 μm, 10 μm, and 11 μm.

Hereinafter, the efficiency (brightness) of light outputted from the opposing substrate 20 toward the element substrate 10 is described with reference to FIG. 8 in comparison with the case of the known technique.

Condition 1 corresponds to this embodiment in which the insulation layer (silicon oxide) with the thickness of approximately 2,600 nm and the opposing electrode 23 (ITO) with the thickness of approximately 140 nm are disposed between the air layer 77 and the output surface of light. Condition 2 corresponds to the known technique in which the insulation layer (silicon oxide) with the thickness of approximately 3,500 nm and the opposing electrode 23 (ITO) with the thickness of approximately 140 nm are disposed between the air layer 77 and the output surface of light. In the graph, the case of condition 1 is indicated with a solid line, while the case of condition 2 is indicated with a broken line.

Prototypes of condition 1 and condition 2 were respectively manufactured, and it has been confirmed that the efficiency obtained in the optical simulation matches the efficiency obtained in the prototypes. In other words, validity of the simulation result has been confirmed.

As shown in FIG. 8, in the case of condition 1 (in this embodiment), the efficiency is 75.2% when the pixel dimension is 7 μm, 83.4% when the pixel dimension is 8.5 μm, 84.8% when the pixel dimension is 10 μm, and 86.8% when the pixel dimension is 11 μm. In the case of condition 2 (in the known technique), the efficiency is 73.8% when the pixel dimension is 7 μm, 82.5% when the pixel dimension is 8.5 μm, 84.1% when the pixel dimension is 10 μm, and 86.1% when the pixel dimension is 11 μm. As can be understood from above, in the case where the pixel dimensions are the same, the efficiency of condition 1 is higher than that of condition 2 by 0.7% to 1.2%. In other word, the brightness of light outputted from the opposing substrate 20 toward the element substrate 10 in condition 1 (in this embodiment) is higher than that in condition 2 (in the known technique).

As described thus far, the dimension between the tip portion 71b of the groove 71 and the output surface 75a in this embodiment is shorter than the dimension between the tip portion 92b of the groove 92 and the output surface 97a in the known technique by approximately 900 nm. With this, an irradiation area of light that passes through the opening region without being blocked by the light blocking unit in this embodiment is wider than that in the known technique. Therefore, the brightness of light outputted from the opposing substrate 20 toward the element substrate 10 in the condition corresponding to this embodiment (condition 1) is made to be higher so that brighter display can be realized than the brightness thereof in the condition corresponding to the known technique (condition 2).

### Manufacturing Method for Opposing Substrate

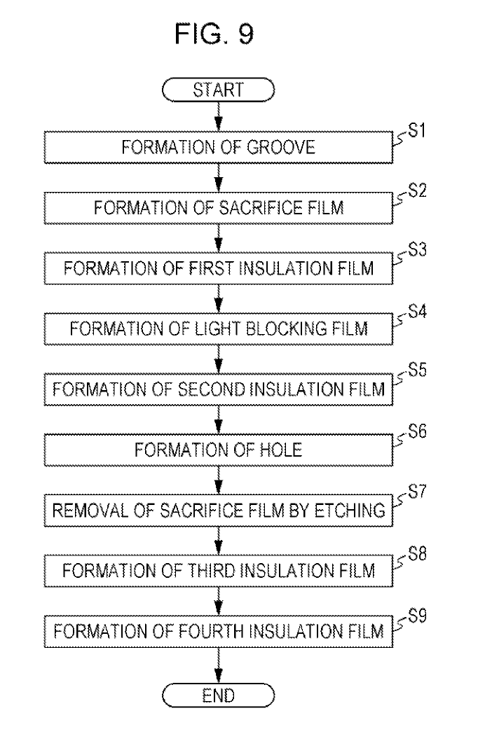

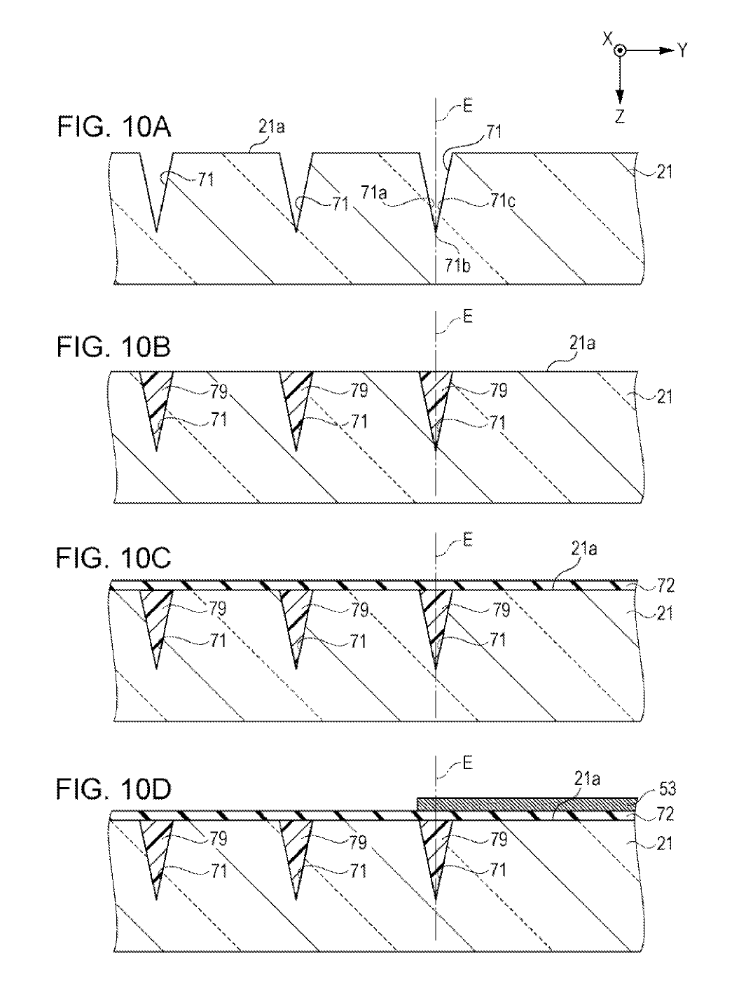

FIG. 9 is a process flowchart illustrating a manufacturing method for the opposing substrate. FIGS. 10A through 12 are views corresponding to FIG. 7, more specifically are schematic cross-sectional views each of which illustrates a state of the opposing substrate after having experienced the corresponding process step shown in FIG. 9. In order to facilitate understanding of the drawings, the location of the front surface 21a of the opposing substrate main section 21 in FIGS. 10A through 12 is made to differ from the location of the front surface 21a of the opposing substrate main section 21 in FIG. 7 (upside down). To be more specific, the front surface 21a of the opposing substrate main section 21 is disposed on the lower side of the opposing substrate main section 21 in FIG. 7, whereas in FIG. 10A through 12, it is disposed on the upper side of the opposing substrate main section 21. Dot-dash lines in FIGS. 10A through 12 each indicate the border of the pixel region E, and the left side of the dot-dash line corresponds to the pixel region E.

Hereinafter, the manufacturing method for the opposing substrate 20 will be described with reference to FIGS. 9 through 12. Since other process steps than the process steps illustrated in FIG. 9 are based on the known technique, descriptions thereof are omitted herein.

In step S1 in FIG. 9, a hard mask made of, for example, aluminum is formed on the front surface 21a of the opposing substrate main section 21, then the opposing substrate main section 21 is etched in the Z direction using a known etching technique such as dry etching in which the above hard mask is used as an etching mask so as to form the grooves 71. The hard mask is removed by etching after the grooves 71 having been formed.

FIG. 10A illustrates a state after step S1 has been carried out. As shown in FIG. 10A, the grooves 71 are formed in the front surface 21a of the opposing substrate main section 21. Each of the grooves 71 has the slopes 71a and 71c that intersect with the Z direction, and the slopes 71a and 71c are connected to each other toward the Z direction side so as to form the tip portion 71b along the X direction. The dimension of the groove 71 in the Y direction of the opposing substrate main section 21 on the front surface 21a side (opening dimension) is approximately 1,000 nm to 2,000 nm. The dimension of the groove 71 in the Z direction (depth) is approximately 30,000 nm to 35,000 nm.

In step S2 in FIG. 9, silicon is deposited on the front surface 21a of the opposing substrate main section 21 using a known deposition technique such as CVD; thereafter a film reduction process is performed with chemical mechanical polishing (hereinafter, called “CMP”) to remove a portion of the silicon that is deposited above the slopes 71a and 71c, thereby forming sacrifice films 79. The sacrifice film 79 may be formed by using resin material as a material to configure the sacrifice film 79 in which the resin material is applied using a spin coat technique or the like.

FIG. 10B illustrates a state after step S2 has been carried out. As shown in the drawing, the interior of each of the grooves 71 is filled with the sacrifice film 79. Unevenness (steps) formed in the front surface of the opposing substrate main section 21 due to the grooves 71 is reduced with the sacrifice films 79, and the side surface of the groove 71 (slopes 71a, 71c) is protected with the sacrifice film 79 as well.

In step S3 in FIG. 9, silicon oxide is deposited using a known deposition technique such as a plasma CVD method or the like so as to form the first insulation film 72. The first insulation film 72 is approximately 200 nm thick.

FIG. 10C illustrates a state after step S3 has been carried out. The front surface 21a of the opposing substrate main section 21 is covered with the first insulation film 72. Because the step in a portion where the groove is formed is reduced with the sacrifice film 79, defects such as a step coverage fault and the like can be suppressed even if the thickness of the first insulation layer 72 is caused to be thinner. In other words, it is possible to make the thickness of the first insulation film 72 be thinner by using the sacrifice film 79.

In step S4 in FIG. 9, titanium nitride, for example, is deposited across the entire surface using a known technique such as sputtering, CVD, or the like; thereafter, the deposited material is processed to be in a predetermined shape (frame form) by dry etching using a mixed gas of chlorine, oxygen, and the like so as to form the light blocking film 53. The light blocking film 53 is approximately 100 nm to 200 nm thick. Any material having a light blocking property can be used as a material to configure the light blocking film 53; that is, an alloy including at least one metal among aluminum (Al), molybdenum (Mo), tungsten (W), titanium (Ti), Tantalum (Ta), chromium (Cr), and so on; metal silicide; poly-silicide; nitride; or a member in which the above materials are laminated can be used as such material.

FIG. 10D illustrates a state after step S4 has been carried out. The light blocking film 53 is disposed in the circumference of the pixel region E and also disposed so as to overlap with the border of the pixel region E. As a result, the groove 71 (sacrifice film 79) formed on the pixel region E is covered with the first insulation film 72 and the light blocking film 53.

A configuration in which the light blocking film 53 is disposed in the circumference of the pixel region E and the groove 71 (sacrifice film 79) formed on the border of the pixel region E is not covered with the light blocking film 53, may be employed.

In step S5 in FIG. 9, silicon oxide is deposited using a known technique such as plasma CVD, for example, so as to form the second insulation film 73. The second insulation film 73 is approximately 600 nm to 800 nm thick.

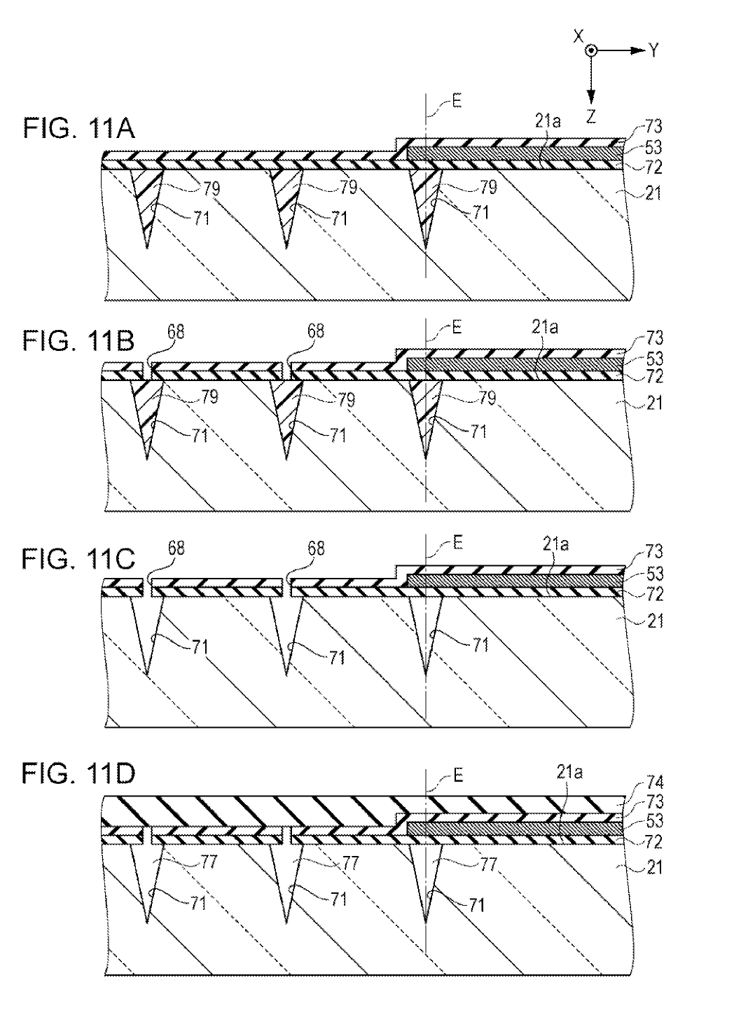

FIG. 11A illustrates a state after step S5 has been carried out. The first insulation film 72 and the light blocking film 53 are covered with the second insulation film 73. The second insulation film 73 protects the light blocking film 53 so that the light blocking film 53 is prevented from being corroded during a process of removing the sacrifice film 79 by etching (step S7) to be explained later in detail.

In step S6 in FIG. 9, the holes 68 penetrating the first insulation film 72 and the second insulation film 73 are formed using a known technique such as dry retching using a mixed gas of fluorocarbon (cyclobutan octafluoride), oxygen, and the like. The shape of the hole 68 is circular, and the dimension (diameter) of the hole 68 is approximately equal to or less than 800 nm. It is preferable for the dimension of the hole 68 to be smaller.

FIG. 11B illustrates a state after step S6 has been carried out. As shown in the drawing, each of the holes 68 exposes part of the sacrifice film 79. The hole 68 is supplied with an active species (for example, chlorine trifluoride) used for etching the sacrifice film 69 in the process of removing the sacrifice film 79 by etching (step S7) to be explained later in detail, so as to serve as a supply-discharge hole through which reaction products of the sacrifice film 79 and the active species are discharged (exhausted). Note that the hole 68 is not provided in the groove 71 that is disposed on the border of the pixel region E.

In step S7 in FIG. 9, the sacrifice film 79 filling the groove 71 is removed by using a known technique such as dry etching using a reaction gas such as chlorine trifluoride, for example. As described above, the active species used for etching the sacrifice film 79 is supplied through the hole 68 and etching products are discharged therethrough.

FIG. 11C illustrates a state after step S7 has been carried out. As shown in the drawing, the sacrifice film 79 that filled the groove 71 has been removed by etching so that a space is formed in the interior of the groove 71. As described earlier, the grooves 71 are formed in a lattice pattern when seen from above, and the grooves 71 in the drawing are connected with each other. Although the hole 68 is not formed in the groove 71 disposed on the border of the pixel region E, the sacrifice film 79 filling the groove 71 that is disposed on the border of the pixel region E is also removed by etching via the hole 68 provided in another groove 71 adjacent to the groove 71.

In step S8 in FIG. 9, silicon oxide is deposited using a known technique such as plasma CVD, for example. The silicon oxide is approximately 2,500 nm thick. Thereafter, the flattening process (film reduction process) is performed with CMP or the like, for example, to decrease the thickness of the silicon oxide to approximately 1,100 nm to 1,400 nm, thereby forming the third insulation film 74. The CMP makes it possible to quickly obtain a flatly polished surface with a combination of chemical action due to chemical components included in a polishing solution and mechanical action due to relative movement between a polishing agent and the opposing substrate 20. More specifically, in the CMP, a surface plate to which polishing cloth (pad) is attached and a holder holding the opposing substrate 20 are relatively rotated so as to perform polishing; the polishing cloth is made of unwoven fabric, urethane foam, porous fluorine resin, and the like. As a result, the third insulation film 74 is allowed to have a flat surface. The third insulation film 74 is approximately 1,100 nm to 1,400 nm thick.

FIG. 11D illustrates a state after step 8 has been carried out. As shown in the drawing, the opening portion of the hole 68 is closed by the third insulation film 74. In this case, the interior of the groove 71 is sealed in a state of the atmosphere when the silicon oxide was deposited. To be more specific, the gas used when the silicon oxide was deposited is confined to the interior of the groove 71 so as to form the air layer 77. In other words, the material (air layer 77) having a lower refractive index than that of the opposing substrate main section 21 (quartz) is confined to the interior of the groove 71, or a region that is enclosed by the slopes 71a, 71c of the groove 71 and the first insulation film 72.

As described above, the third insulation film 74 is a constituent element of the sealing layer 76, and it is preferable for the film to be thinner. Because the thickness of the third insulation film 74 can be made thinner by making the diameter of the hole 68 smaller, it is preferable for the diameter of the hole 68 to be smaller.

In step 9 in FIG. 9, silicon oxide is deposited by using a known technique such as plasma CVD so as to form the fourth insulation film 75. The fourth insulation film 75 is approximately 100 nm thick.

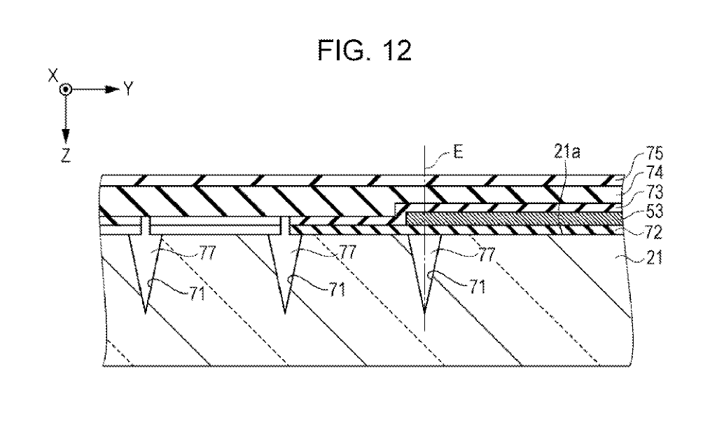

FIG. 12 illustrates a state after step S9 has been carried out. In the CMP process, since the film reduction process is performed mechanically using a polishing agent, minute scratches are produced in the polished surface. The fourth insulation film 75 contributes to reducing the influence of such scratches. In other words, by covering the polished surface having minute scratches (unevenness surface) with the fourth insulation film 75, the influence of the scratches is reduced and a smooth surface is consequently formed.

### Second Embodiment

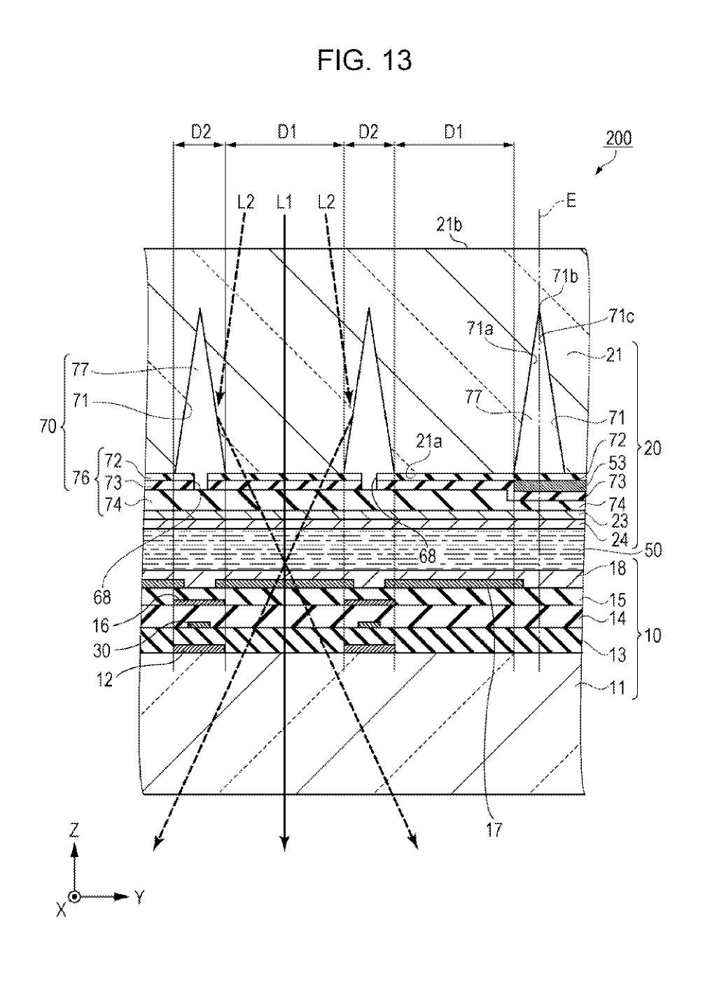

FIG. 13 corresponds to FIG. 7, and is a schematic cross-sectional view of a liquid crystal device according to a second embodiment.

Hereinafter, a liquid crystal device 200 according to the second embodiment will be described with reference to FIG. 13 while focusing on different points from the first embodiment. It is to be noted that same reference numerals will be given to same constituent elements as those in the first embodiment, and redundant descriptions thereof will be omitted.

The liquid crystal device 200 according to this embodiment differs from the first embodiment in that etching is performed, in the process step for the formation of the third insulation film 74 (step S8; see FIG. 9), on a polished surface produced by the CMP, and that the process step for the formation of the fourth insulation film 75 (step S9; see FIG. 9) is omitted. Other configurations are the same as those in the first embodiment.

As shown in FIG. 13, the opposing substrate 20 includes the opposing substrate main section 21, and also includes the first insulation film 72, the light blocking film 53, the second insulation film 73, the third insulation film 74, the opposing electrode 23, the alignment layer 24, and so on that are laminated in series on the front surface 21a of the opposing substrate main section 21.

The process step for the formation of the third insulation film 74 (step S8) is configured of processing to form silicon oxide with the thickness of approximately 2,500 nm using a known technique such as the plasma CVD or the like, processing to perform the flattening process (film reduction process) using the CMP or the like, and processing to perform etching on the polished surface. As described above, it is a different point from the first embodiment that the processing to perform etching on the polished surface is added in step S8.

In the flattening process by the CMP, minute scratches are produced in the polished surface. In the case where the polished surface is etched by dry etching using a reaction gas such as fluorocarbon, by wet etching using hydrofluoric, or the like, for example, the influence of the scratches or the like is lessened so that the polished surface can be formed to be a smooth one. In other words, even if the polished surface is not covered with the fourth insulation film 75, it is possible to lessen the influence of scratches by performing etching on the polished surface.

Because the liquid crystal device 200 of this embodiment does not have the fourth insulation film 75, the thickness of the sealing layer 76 can be made thinner in comparison with the liquid crystal device 100 of the first embodiment. Therefore, in the liquid crystal device 200 of the second embodiment, the dimension between the tip portion 71b of the groove 71 and the output surface 75a is smaller so that the brightness of the light outputted from the opposing substrate 20 toward the element substrate 10 is higher in comparison with the liquid crystal device 100 of the first embodiment.

### Third Embodiment

### Electronic Apparatus

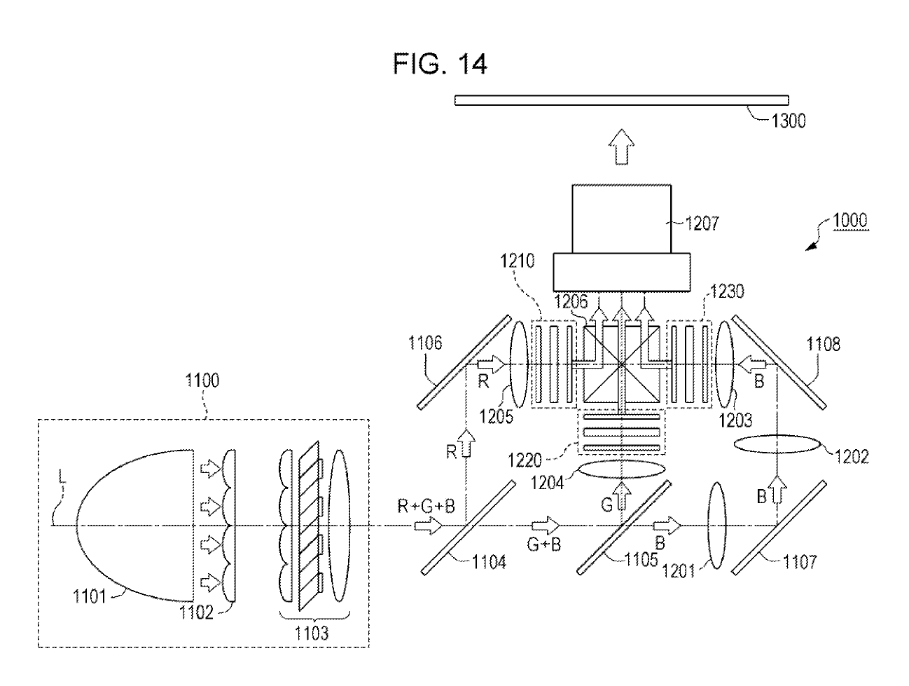

FIG. 14 is a schematic view illustrating a configuration of a projection display apparatus (liquid crystal projector) as an electronic apparatus. As shown in FIG. 14, a projection display apparatus 1000 as an electronic apparatus according to a third embodiment of the invention includes: a polarization illumination device 1100 disposed along a system optical axis L; two dichroic mirrors 1104 and 1105 as light separation elements; three reflection mirrors 1106, 1107, and 1108; five relay lenses 1201, 1202, 1203, 1204, and 1205; three transmissive liquid crystal light valves 1210, 1220, and 1230 as optical modulation units; a cross dichroic prism 1206 as a light combination element; and a projection lens 1207.

The polarization illumination device 1100 is generally configured of a lamp unit 1101 as a light source formed with a white light source such as an ultrahigh pressure mercury lamp or a halogen lamp, an integrator lens 1102, and a polarization conversion element 1103.

The dichroic mirror 1104 reflects red light (R) and transmits green light (G) and blue light (B) included in a polarized light flux emitted from the polarization illumination device 1100. The other dichroic mirror 1105 reflects green light (G) and transmits blue light (B) having passed the dichroic mirror 1104.

The red light (R) reflected by the dichroic mirror 1104, after being reflected by the reflection mirror 1106, enters the liquid crystal light valve 1210 via the relay lens 1205.

The green light (G) reflected by the dichroic mirror 1105 enters the liquid crystal light valve 1220 via the relay lens 1204.

The blue light (B) having passed the dichroic mirror 1105 enters the liquid crystal light valve 1230 via a light guide system configured of the three relay lenses 1201, 1202, 1203 and the two reflection mirrors 1107, 1108.

The liquid crystal light valves 1210, 1220, and 1230 are so disposed as to face the incidence surfaces of the cross dichroic prism 1206 for respective color lights. Color lights having entered the respective liquid crystal light valves 1210, 1220, and 1230 are modulated based on image information (image signal) and outputted toward the cross dichroic prism 1206. This prism is configured by bonding four rectangular prisms; on the inner surfaces of the prism, a dielectric multilayer film that reflects red light and another dielectric multilayer film that reflects blue light are formed in a cross manner. The three color lights are combined by these dielectric multilayer films for representing a color image. The combined light is projected, by the projection lens 1207 as a projection optical system, onto a screen 1300 in which the image is enlarged and displayed.

The liquid crystal device 100 of the first embodiment or the liquid crystal device 200 of the second embodiment is applied to the liquid crystal light valves 1210, 1210, and 1230. The utilization efficiency of light can be improved due to the prisms 70 provided in the liquid crystal device 100 and the liquid crystal device 200, thereby making it possible to provide brighter display.

The invention is not intended to be limited to the aforementioned embodiments, and many modifications can be made thereon without departing from the essential spirit of the invention as set forth in the appended aspects of the invention and the specification as a whole; electro-optical devices derived from such modifications and electronic apparatuses to which such electro-optical devices are applied also fall within the technical scope of the invention.

Many variations can also be considered in addition to the aforementioned embodiments. Several such variations will be described hereinafter.

### First Variation

The invention is not limited to be applied to the liquid crystal devices 100 and 200, and can also be applied to light-emitting devices having organic electroluminescence elements. In other words, by applying the prism 70 to the stated light-emitting devices, it is possible to improve the utilization efficiency of light and provide brighter display.

### Second Variation

Electronic apparatuses to which the liquid crystal devices 100 and 200 can be applied are not limited to the projection display apparatus 1000 of the third embodiment. The liquid crystal devices 100 and 200 can be applied to electronic apparatuses such as, aside from the projection display apparatus 1000, a projection HUD (head-up display), a direct-view HMD (head-mounted display), an electronic book, a personal computer, a digital still camera, a liquid crystal television, a viewfinder or monitor direct-view video recorder, a car navigation system, an information terminal apparatus such as a POS terminal, an electronic notebook, and so on.

The entire disclosure of Japanese Patent Application No. 2013-081027, filed Apr. 9, 2013 is expressly incorporated by reference herein.

What is claimed is:

1. An electro-optical device comprising:
a substrate which has a groove on a side of a first surface of the substrate and transmits light;
a first insulation film which is disposed so as to cover the first surface and part of which keeps a distance from a side surface of the groove;
a light blocking film disposed at a circumference of a pixel region;
a second insulation film disposed so as to cover the first insulation film;
a hole that penetrats the first insulation film and the second insulation film; and
a third insulation film that is disposed so as to cover the second insulation film, the third insulation film closing the hole,
wherein the groove is disposed so as to overlap with a boundary between a first pixel and a second pixel that is disposed adjacent to the first pixel, and
the light blocking film is disposed between the first insulation film and the second insulation film.

2. The electro-optical device according to claim 1,
wherein a sum of the first insulation film, the second insulation film, and the third insulation film is equal to or less than 2,400 nm.

3. The electro-optical device according to claim 1,
wherein a thickness of the first insulation film is equal to or less than 200 nm, a thickness of the second insulation film is equal to or less than 800 nm, and a thickness of the third insulation film is equal to or less than 1,400 nm.

4. The electro-optical device according to claim 1,
wherein a surface of the third insulation film is approximately flat.

5. The electro-optical device according to claim 1,
wherein the third insulation film is covered with a fourth insulation film.

6. The electro-optical device according to claim 1,
wherein the groove is disposed so as to overlap with a border of the pixel region.

7. The electro-optical device according to claim 1,
wherein the light blocking film is disposed so as to overlap with the border of the pixel region.

8. The electro-optical device according to claim 1,
wherein a portion between the side surface of the groove and the first insulation film is filled with a material having a lower refractive index than a refractive index of the substrate.

9. An electronic apparatus comprising:
the electro-optical device according to claim 1.

10. An electronic apparatus comprising:
the electro-optical device according to claim 2.

11. An electronic apparatus comprising:
the electro-optical device according to claim 3.

12. An electronic apparatus comprising:
the electro-optical device according to claim 4.

13. An electronic apparatus comprising:
the electro-optical device according to claim 5.

14. An electronic apparatus comprising:
the electro-optical device according to claim 6.

15. An electronic apparatus comprising:
the electro-optical device according to claim 7.

16. An electronic apparatus comprising:
the electro-optical device according to claim 8.
